(19) United States
(12) Patent Application Publication
(10) Pub. No.: US 2026/0269855 A1
(43) Pub. Date: Sep. 10, 2026

(54) RECEIVER WITH LOW-LOSS TUNABLE MODE SWITCHING

(71) Applicant: QUALCOMM Incorporated, San Diego, CA (US)

(72) Inventors: Andreea BALTEANU, La Jolla, CA (US); Pranith Reddy BYREDDY, San Marcos, CA (US); Prakash THOPPAY EGAMBARAM, San Diego, CA (US); Ahmed ABBAS MOHAMED HELMY, San Diego, CA (US); Marco VIGILANTE, San Diego, CA (US)

(21) Appl. No.: 19/075,103

(22) Filed: Mar. 10, 2025

(51) Int. Cl. H04B 1/16; H04B 1/00; H04B 1/14; H04B 1/30

(52) U.S. Cl. CPC H04B 1/1638; H04B 1/0078; H04B 1/14; H04B 2001/307

(57) ABSTRACT

A system for wireless communications includes a first low-noise amplifier (LNA), a second LNA, first capacitors, and second capacitors. The system also includes first switches, wherein each of the first switches is coupled between an output of the first LNA and a respective one of the first capacitors, and second switches, wherein each of the second switches is coupled between the output of the first LNA and a respective one of the second capacitors. The system also includes third switches, wherein each of the third switches is coupled between an output of the second LNA and a respective one of the first capacitors, and fourth switches, wherein each of the fourth switches is coupled between the output of the second LNA and a respective one of the second capacitors. The system further includes a first mixer coupled to the first capacitors, and a second mixer coupled to the second capacitors.

### FIELD

Aspects of the present disclosure relate generally to wireless communications, and, more particularly, to receivers.

### BACKGROUND

A wireless device may transmit and receive radio frequency (RF) signals in one or more wireless networks (e.g., a fourth generation (4G) network, a fifth generation (5G) network, a wireless local area network (WLAN), etc.). To receive RF signals, the wireless device includes one or more antennas and low-noise amplifiers (LNAs) configured to amplify RF signals received by the one or more antennas.

### SUMMARY

The following presents a simplified summary of one or more implementations in order to provide a basic understanding of such implementations. This summary is not an extensive overview of all contemplated implementations and is intended to neither identify key or critical elements of all implementations nor delineate the scope of any or all implementations. Its sole purpose is to present some concepts of one or more implementations in a simplified form as a prelude to the more detailed description that is presented later.

A first aspect relates to a system for wireless communications. The system includes a first low-noise amplifier (LNA), a second LNA, first capacitors, and second capacitors. The system also includes first switches, wherein each of the first switches is coupled between an output of the first LNA and a respective one of the first capacitors, and second switches, wherein each of the second switches is coupled between the output of the first LNA and a respective one of the second capacitors. The system also includes third switches, wherein each of the third switches is coupled between an output of the second LNA and a respective one of the first capacitors, and fourth switches, wherein each of the fourth switches is coupled between the output of the second LNA and a respective one of the second capacitors. The system further includes a first mixer coupled to the first capacitors, and a second mixer coupled to the second capacitors.

A second aspect relates to a system for wireless communications. The system includes a first low-noise amplifier (LNA), a second LNA, and capacitors. The system also includes first switches, wherein each of the first switches is coupled between an output of the first LNA and a respective one of the capacitors, and second switches, wherein each of the second switches is coupled between an output of the second LNA and a respective one of the capacitors. The system further includes a mixer coupled to the capacitors.

### BRIEF DESCRIPTION OF THE DRAWINGS

FIG. 1 shows an example of a receiver including low-noise amplifiers (LNAs), switches, and tunable capacitors according to certain aspects of the present disclosure.

FIG. 2 shows an exemplary implementation of the tunable capacitors of FIG. 1 according to certain aspects of the present disclosure.

FIG. 3 shows an example of a receiver including LNAs and a routing and capacitor circuit according to certain aspects of the present disclosure.

FIG. 4A shows a first portion of an exemplary implementation of the routing and capacitor circuit of FIG. 3 according to certain aspects of the present disclosure.

FIG. 4B shows a second portion of the exemplary implementation of the routing and capacitor circuit of FIG. 3 according to certain aspects of the present disclosure.

FIG. 5 shows an example in which the receiver of FIG. 3 further includes a bypass path according to certain aspects of the present disclosure.

FIG. 6A shows a first portion of an exemplary implementation of the routing and capacitor circuit of FIG. 5 according to certain aspects of the present disclosure.

FIG. 6B shows a second portion of the exemplary implementation of the routing and capacitor circuit of FIG. 5 according to certain aspects of the present disclosure.

FIG. 7 shows an example in which the receiver of FIG. 5 further includes an attenuator according to certain aspects of the present disclosure.

FIG. 8 shows an exemplary implementation of low-noise amplifiers according to certain aspects of the present disclosure.

FIG. 9 shows an example of receive chains including baseband filters and analog-to-digital converters (ADCs) according to certain aspects of the present disclosure.

FIG. 10 is a diagram of an environment including an electronic device that includes a transceiver according to certain aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

A wireless device may include low-noise amplifiers (LNAs) configured to amplify radio frequency (RF) signals received by one or more antennas. The wireless device may be implemented as any suitable wireless device, such as as a cellular or mobile phone, a gaming device, a navigation device, a media device, a laptop computer, a desktop computer, a tablet computer, a server computer, a network-attached storage (NAS) device, a smart appliance, a vehicle-based communication system, an Internet of Things (IoT) device, a sensor or security device, an asset tracker, and so forth.

The wireless device may support wireless communications in multiple frequency bands and/or multiple wireless technologies. The multiple frequency bands may include any one or more of the fourth generation (4G) bands, fifth generation (5G) bands, WLAN bands, millimeter wave (mmWave) bands, and the like.

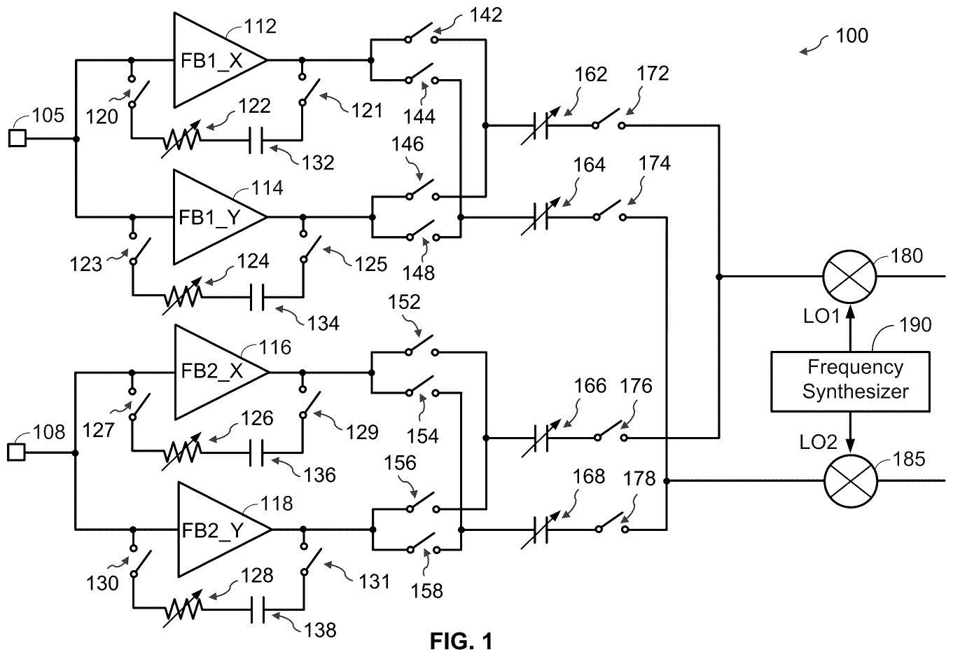

FIG. 1 shows an example of a multi-band receiver 100 according to certain aspects. For example, the multi-band receiver 100 may support reception of RF signals in a first frequency band (labeled “FB1”) and reception of RF signals in a second frequency band (labeled “FB2”). For example, in some implementations, the first frequency band may include a low band (LB) and the second frequency band may include a mid-high band (MHB). In this example, the LB may be within a frequency range of 617 to 960 MHz and the MHB may be within a frequency range of 1427 to 2690 MHz. However, it is to be appreciated that the first frequency band and the second frequency band are not limited to this example and that the first frequency band and the second frequency may cover other frequencies in other examples.

In the example in FIG. 1, the receiver 100 includes a first low-noise amplifier (LNA) 112, a second LNA 114, a third LNA 116, and a fourth LNA 118. The first LNA 112 and the second LNA 114 may be configured to amplify RF signals in the first frequency band (e.g., LB) and the third LNA 116 and the fourth LNA 118 may be configured to amplify RF signals in the second frequency band (e.g., MHB). In this example, the inputs of the first LNA 112 and the second LNA 114 are coupled to a first input port 105 to receive RF signals in the first frequency band via the first input port 105, and the inputs of the third LNA 116 and the fourth LNA 118 are coupled to a second input port 108 to receive RF signals in the second frequency band via the second input port 108. The input ports 105 and 108 may be coupled to the same antenna (not shown in FIG. 1) or different antennas (not shown in FIG. 1).

In certain aspects, each of the LNAs 112, 114, 116, and 118 includes one or more transistors (e.g., a transistor configured as a common-source amplifier, complementary transistors implementing an inverting amplifier, or the like). In this example, the transistors in the first LNA 112 and the second LNA 114 may have a different gate length than the transistors in the third LNA 116 and the fourth LNA 118. For example, a first gate length may be selected for the transistors in the first LNA 112 and the second LNA 114 to improve performance (e.g., receiver sensitivity and input matching) in the first frequency band (e.g., LB) while a second gate length different from the first gate length may be selected for the transistors in the third LNA 116 and the fourth LNA 118 to improve performance (e.g., receiver sensitivity and input matching) in the second frequency band (e.g., MHB).

In the example in FIG. 1, the receiver 100 also includes tunable feedback resistors 122, 124, 126, and 128, feedback capacitors 132, 134, 136, and 138, and feedback switches 120, 121, 123, 125, 127, 129, 130, and 131. The tunable feedback resistors 122, 124, 126, and 128 allow the gains of the LNAs 112, 114, 116, and 118 to be individually tuned, as discussed further below.

In this example, the tunable feedback resistor 122, the feedback capacitor 132, and the feedback switches 120 and 121 are coupled in a feedback loop between the output and the input of the first LNA 112. The feedback switches 120 and 121 may be closed (i.e., turned on) to enable the feedback loop and opened (i.e., turned off) to disable the feedback loop. When the feedback loop is enabled, the resistance of the tunable feedback resistor 122 may be tuned to tune the gain of the first LNA 112.

The tunable feedback resistor 124, the feedback capacitor 134, and the feedback switches 123 and 125 are coupled in a feedback loop between the output and the input of the second LNA 114. The feedback switches 123 and 125 may be closed (i.e., turned on) to enable the feedback loop and opened (i.e., turned off) to disable the feedback loop. When the feedback loop is enabled, the resistance of the tunable feedback resistor 124 may be tuned to tune the gain of the second LNA 114.

The tunable feedback resistor 126, the feedback capacitor 136, and the feedback switches 127 and 129 are coupled in a feedback loop between the output and the input of the third LNA 116. The feedback switches 127 and 129 may be closed (i.e., turned on) to enable the feedback loop and opened (i.e., turned off) to disable the feedback loop. When the feedback loop is enabled, the resistance of the tunable feedback resistor 126 may be tuned to tune the gain of the third LNA 116.

The tunable feedback resistor 128, the feedback capacitor 138, and the feedback switches 130 and 131 are coupled in a feedback loop between the output and the input of the fourth LNA 118. The feedback switches 130 and 131 may be closed (i.e., turned on) to enable the feedback loop and opened (i.e., turned off) to disable the feedback loop. When the feedback loop is enabled, the resistance of the tunable feedback resistor 128 may be tuned to tune the gain of the fourth LNA 118.

In the example in FIG. 1, the receiver 100 also includes routing switches 142, 144, 146, 148, 152, 154, 156, and 158, tunable capacitors 162, 164, 166, and 168, switches 172, 174, 176, and 178, a first mixer 180, a second mixer 185, and a frequency synthesizer 190. As discussed further below, the routing switches 142, 144, 146, 148, 152, 154, 156, and 158 allow the output RF signal of each of the LNAs 112, 114, 116, and 118 to be selectively routed to the first mixer 180 or the second mixer 185 to support different modes of operation.

In this example, the tunable capacitor 162 is selectively coupled to the first mixer 180 by the switch 172 and the tunable capacitor 164 is selectively coupled to the second mixer 185 by the switch 174. The routing switch 142 is coupled between the output of the first LNA 112 and the tunable capacitor 162, and the routing switch 144 is coupled between the output of the first LNA 112 and the tunable capacitor 164. The routing switch 146 is coupled between the output of the second LNA 114 and the tunable capacitor 162, and the routing switch 148 is coupled between the output of the second LNA 114 and the tunable capacitor 164. The routing switches 142 and 144 allow the output RF signal of the first LNA 112 to be selectively routed to the first mixer 180 (e.g., by closing the switch 142 and opening the switch 144) or routed to the second mixer 185 (e.g., by closing the switch 144 and opening the switch 142). The routing switches 146 and 148 allow the output RF signal of the second LNA 114 to be selectively routed to the first mixer 180 (e.g., by closing the switch 146 and opening the switch 148) or routed to the second mixer 185 (e.g., by closing the switch 148 and opening the switch 146).

In this example, the tunable capacitor 166 is selectively coupled to the first mixer 180 by the switch 176 and the tunable capacitor 168 is selectively coupled to the second mixer 185 by the switch 178. The routing switch 152 is coupled between the output of the third LNA 116 and the tunable capacitor 166, and the routing switch 154 is coupled between the output of the third LNA 116 and the tunable capacitor 168. The routing switch 156 is coupled between the output of the fourth LNA 118 and the tunable capacitor 166, and the routing switch 158 is coupled between the output of the fourth LNA 118 and the tunable capacitor 168. The routing switches 152 and 154 allow the output RF signal of the third LNA 116 to be selectively routed to the first mixer 180 (e.g., by closing the switch 152 and opening the switch 154) or routed to the second mixer 185 (e.g., by closing the switch 154 and opening the switch 152). The routing switches 156 and 158 allow the output RF signal of the fourth LNA 118 to be selectively routed to the first mixer 180 (e.g., by closing the switch 156 and opening the switch 158) or routed to the second mixer 185 (e.g., by closing the switch 158 and opening the switch 156).

The tunable capacitors 162, 164, 166, and 168 block the DC bias voltages at the outputs of the LNAs 112, 114, 116, and 118 while passing the output RF signals of the LNAs 112, 114, 116, and 118. The tunable capacitors 162, 164, 166, and 168 also provide tunable impedance matching (i.e., tunable S11 parameter) between the mixers 180 and 185 and the LNAs 112, 114, 116, and 118 by tuning the capacitances of the tunable capacitors 162, 164, 166, and 168. A tunable capacitor may also be referred to as a variable capacitor or another term.

The frequency synthesizer 190 (e.g., one or more phase-locked loops (PLLs), one or more ring oscillators, etc.) is coupled to the first mixer 180 and the second mixer 185. The frequency synthesizer 190 is configured to generate a first local oscillator signal (labeled “LO1”) and output the first local oscillator signal to the first mixer 180. The frequency synthesizer 190 is also configured to generate a second local oscillator signal (labeled “LO2”) and output the second local oscillator signal to the second mixer 185. The first local oscillator signal and the second local oscillator signal may have the same frequency or different frequencies. Also, the frequency synthesizer 190 may be configured to individually tune the frequencies of the first local oscillator signal and the second local oscillator signal based on the mode of operation of the receiver 100, as discussed further below.

The first mixer 180 is configured to receive one or more output RF signals from one or more of the LNAs 112, 114, 116, and 118, mix the one or more output RF signals with the first local oscillator signal to frequency downconvert the one or more output RF signals into one or more baseband signals or one or more intermediate frequency (IF) signals, and output the one or more baseband signals or the one or more IF signals to a first receive chain (not shown in FIG. 1) for further processing. The first receive chain may include a filter, an analog-to-digital converter (ADC), a digital signal processor (DSP), and/or other components. In certain aspects, the frequency synthesizer 190 tunes the frequency of the first local oscillator signal to allow the first mixer 180 to frequency downconvert RF signals with different frequencies.

The second mixer 185 is configured to receive one or more output RF signals from one or more of the LNAs 112, 114, 116, and 118, mix the one or more output RF signals with the second local oscillator signal to frequency downconvert the one or more output RF signals into one or more baseband signals or one or more IF signals, and output the one or more baseband signals or the one or more IF signals to a second receive chain (not shown in FIG. 1) for further processing. The second receive chain may include a filter, an ADC, a DSP, and/or other components. In certain aspects, the frequency synthesizer 190 tunes the frequency of the second local oscillator signal to allow the second mixer 185 to frequency downconvert RF signals with different frequencies.

As discussed above, the routing switches 142, 144, 146, 148, 152, 154, 156, and 158 allow the output RF signal of each of the LNAs 112, 114, 116, and 118 to be selectively routed to the first mixer 180 or the second mixer 185 to support different modes of operation. For example, in one mode, the output signals of the first LNA 112 and the second LNA 114 may both be routed to the same mixer (i.e., the first mixer 180 or the second mixer 186) using the routing switches 142, 144, 146, and 148. In another mode, the output signals of the first LNA 112 and the second LNA 114 may be routed to different mixers using the routing switches 142, 144, 146, and 148. For example, the output signal of the first LNA 112 may be routed to the first mixer 180 and the output signal of the second LNA 114 may be routed to the second mixer 185, or vice versa. This mode may be used, for example, to facilitate carrier aggregation in which the first LNA 112 and the second LNA 114 are used to receive an RF signal including a first carrier component and a second carrier component in the first frequency band. In this example, the first mixer 180 may be used to frequency downconvert the first carrier component and the second mixer 185 may be used to frequency downconvert the second carrier component. In this example, the feedback resistors 122 and 124 may be individually tuned to individually tune the gains for the first carrier component and the second carrier component.

In another mode, the output signals of the third LNA 116 and the fourth LNA 118 may both be routed to the same mixer (i.e., the first mixer 180 or the second mixer 186) using the routing switches 152, 154, 156, and 158. In another mode, the output signals of the third LNA 116 and the fourth LNA 118 may be routed to different mixers using the routing switches 152, 154, 156, and 158 (e.g., to facilitate carrier aggregation in the second frequency band). For example, the output signal of the third LNA 116 may be routed to the first mixer 180 and the output signal of the fourth LNA 118 may be routed to the second mixer 185, or vice versa.

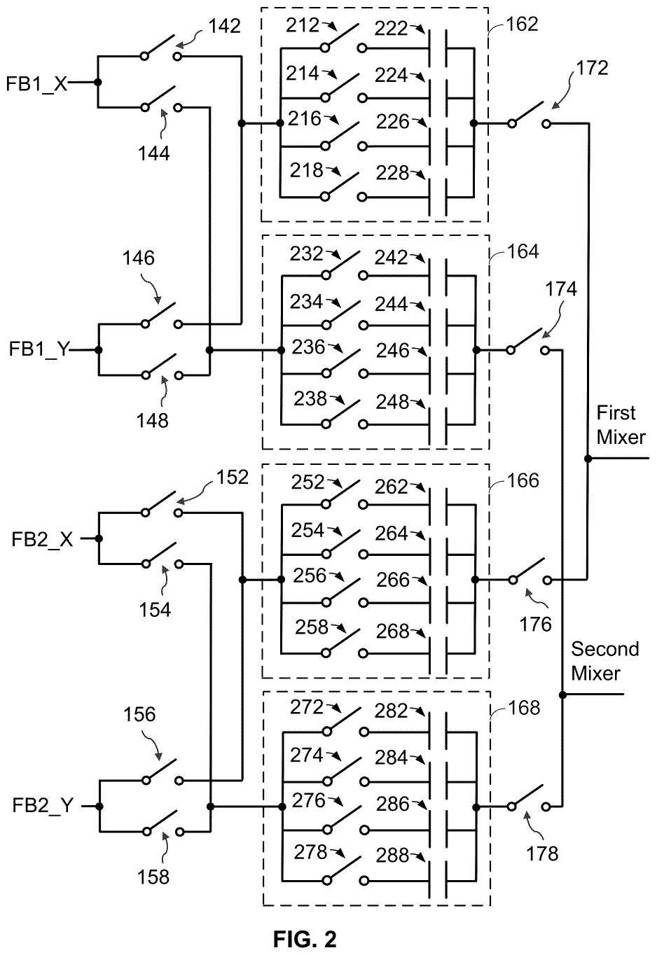

FIG. 2 shows an example in which each of the tunable capacitors 162, 164, 166, and 168 is implemented with a respective switchable capacitor array (i.e., capacitor bank). In this example, the tunable capacitor 162 includes switches 212, 214, 216, and 218 and capacitors 222, 224, 226, and 228 in which each of the switches 212, 214, 216, and 218 is coupled in series with a respective one of the capacitors 222, 224, 226, and 228. In this example, the capacitance of the tunable capacitor 162 is tuned by controlling the on/off states of the switches 212, 214, 216, and 218.

The tunable capacitor 164 includes switches 232, 234, 236, and 238 and capacitors 242, 244, 246, and 248 in which each of the switches 232, 234, 236, and 238 is coupled in series with a respective one of the capacitors 242, 244, 246, and 248. In this example, the capacitance of the tunable capacitor 164 is tuned by controlling the on/off states of the switches 232, 234, 236, and 238.

The tunable capacitor 166 includes switches 252, 254, 256, and 258 and capacitors 262, 264, 266, and 268 in which each of the switches 252, 254, 256, and 258 is coupled in series with a respective one of the capacitors 262, 264, 266, and 268. In this example, the capacitance of the tunable capacitor 166 is tuned by controlling the on/off states of the switches 252, 254, 256, and 258.

The tunable capacitor 168 includes switches 272, 274, 276, and 278 and capacitors 282, 284, 286, and 288 in which each of the switches 272, 274, 276, and 278 is coupled in series with a respective one of the capacitors 282, 284, 286, and 288. In this example, the capacitance of the tunable capacitor 168 is tuned by controlling the on/off states of the switches 272, 274, 276, and 278.

It is desirable to reduce the signal losses in the paths between the outputs of the LNAs 112, 114, 116, and 118 and the mixers 180 and 185 to improve receiver performance. In the example shown in FIG. 2, the routing switches 142, 144, 146, 148, 152, 154, 156, and 158 are coupled in series with the capacitor switches 212, 214, 216, 218, 232, 234, 236, 238, 252, 254, 256, 258, 272, 274, 276, and 278. As a result, the signal losses in the routing switches 142, 144, 146, 148, 152, 154, 156, and 158 are combined with the signal losses in the capacitor switches 212, 214, 216, 218, 232, 234, 236, 238, 252, 254, 256, 258, 272, 274, 276, and 278, which increases the total signal losses between the LNAs 112, 114, 116, and 118 and the mixers 180 and 185.

To address this, aspects of the present disclosure provide parallel switches that perform both signal routing and capacitor switching instead of using separate routing switches and capacitor switches coupled in series. This eliminates the additional signal losses associated with coupling the routing switches and the capacitor switches in series, thereby reducing the total signal losses in the receiver. The above features and other features of the present disclosure are discussed further below.

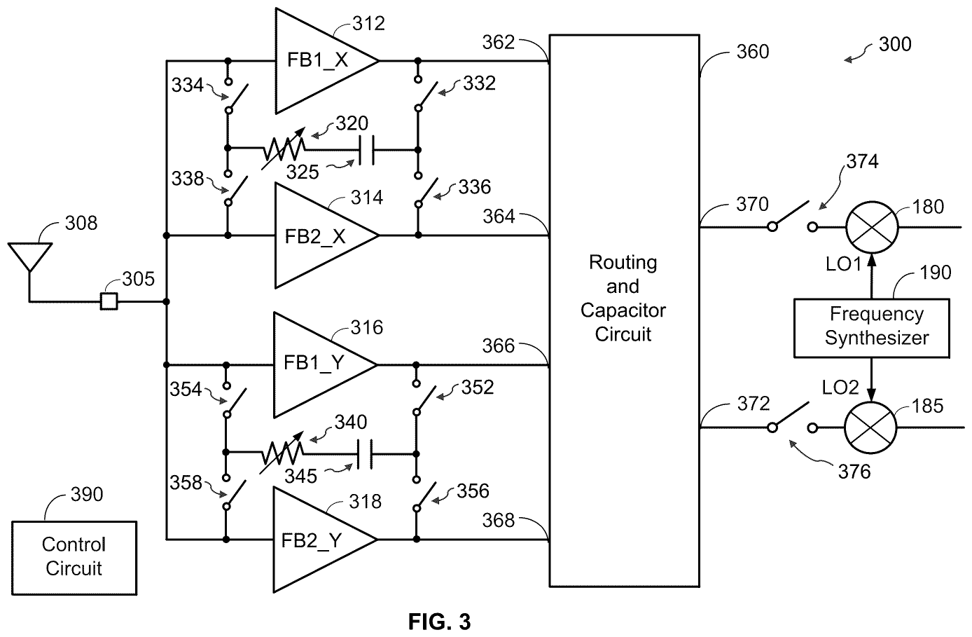

FIG. 3 shows an example of a multi-band receiver 300 according to certain aspects. In the example in FIG. 3, the receiver 300 includes a first LNA 312, a second LNA 314, a third LNA 316, and a fourth LNA 318. The first LNA 312 and the third LNA 316 may be configured to amplify RF signals in the first frequency band (e.g., LB) and the second LNA 314 and the fourth LNA 318 may be configured to amplify RF signals in the second frequency band (e.g., MHB). In this example, the inputs of the LNAs 312, 314, 316, and 318 are coupled to an input port 305 to receive RF signals in the first frequency band and the second frequency band. The input port 305 may be coupled to one or more antennas 308 for receiving the RF signals. It is to be appreciated that input port 305 may be coupled to the one or more antennas 308 via one or more diplexers (not shown), one or more duplexers (not shown), and/or one or more switches.

In certain aspects, each of the LNAs 312, 314, 316, and 318 includes one or more transistors (e.g., a transistor configured as a common-source amplifier, complementary transistors implementing an inverting amplifier, or the like). In this example, the transistors in the first LNA 312 and the third LNA 316 may have a different gate length than the transistors in the second LNA 314 and the fourth LNA 318. For example, a first gate length may be selected for the transistors in the first LNA 312 and the third LNA 316 to improve performance (e.g., receiver sensitivity and input matching) in the first frequency band (e.g., LB) while a second gate length different from the first gate length may be selected for the transistors in the second LNA 314 and the fourth LNA 318 to improve performance (e.g., receiver sensitivity and input matching) in the second frequency band (e.g., MHB). For the example where the first frequency band includes the LB and the second frequency band includes the MHB, the first gate length (e.g., 36 nm) may be longer than the second gate length (e.g., 20 nm). In certain aspects, the first frequency band (e.g., LB) is below one GHz and the second frequency band (e.g., MHB) is above one GHz. However, it is to be appreciated that the present disclosure is not limited to this example.

In the example in FIG. 3, the receiver 300 also includes a first tunable feedback resistor 320, a first feedback capacitor 325, and feedback switches 332, 334, 336, and 336. The feedback switches 332 and 334, the first tunable feedback resistor 320, and the first feedback capacitor 325 are coupled in a first feedback loop between the output and the input of the first LNA 312. In this example, the feedback switches 332 and 334 are configured to selectively couple the first tunable feedback resistor 320 and the first feedback capacitor 325 between the output and the input of the first LNA 312. The feedback switches 336 and 338, the first tunable feedback resistor 320, and the first feedback capacitor 325 are coupled in a second feedback loop between the output and the input of the second LNA 314. In this example, the feedback switches 336 and 338 are configured to selectively couple the first tunable feedback resistor 320 and the first feedback capacitor 325 between the output and the input of the second LNA 314. Thus, in this example, the first tunable feedback resistor 320 and the first feedback capacitor 325 are shared by the first LNA 312 and the second LNA 314, which reduces the number of components in the receiver 300.

The receiver 300 also includes a second tunable feedback resistor 340, a second feedback capacitor 345, and feedback switches 352, 354, 356, and 356. The feedback switches 352 and 354, the second tunable feedback resistor 340, and the second feedback capacitor 345 are coupled in a third feedback loop between the output and the input of the third LNA 316. In this example, the feedback switches 352 and 354 are configured to selectively couple the second tunable feedback resistor 340 and the second feedback capacitor 345 between the output and the input of the third LNA 316. The feedback switches 356 and 358, the second tunable feedback resistor 340, and the second feedback capacitor 345 are coupled in a fourth feedback loop between the output and the input of the fourth LNA 318. In this example, the feedback switches 356 and 358 are configured to selectively couple the second tunable feedback resistor 340 and the second feedback capacitor 345 between the output and the input of the fourth LNA 318. Thus, in this example, the second tunable feedback resistor 340 and the second feedback capacitor 345 are shared by the third LNA 316 and the fourth LNA 318, which reduces the number of components in the receiver 300.

In the example in FIG. 3, the on/off states of the feedback switches 332, 334, 336, 338, 352, 354, 356, and 358 are controlled by a control circuit 390. For ease of illustration, the individual connections between the control circuit 390 and the feedback switches 332, 334, 336, 338, 352, 354, 356, and 358 are not shown in FIG. 3. In certain aspects, the control circuit 390 switches the receiver 300 between different modes of operation using the feedback switches 332, 334, 336, 338, 352, 354, 356, and 358. For example, in one mode, the control circuit 390 configures the receiver 300 to receive RF signals in the first frequency band (e.g., LB). In this mode, the control circuit 390 closes the feedback switches 332, 334, 352, and 354 (which enables the first feedback loop and the third feedback loop) and opens the feedback switches 336, 338, 356, and 358 (which disables the second feedback loop and the fourth feedback loop). In this mode, the resistances of the first tunable feedback resistor 320 and the second tunable feedback resistor 340 may be tuned to tune the gains of the first LNA 312 and the third LNA 316, respectively.

In another mode, the control circuit 390 configures the receiver 300 to receive RF signals in the second frequency band (e.g., MHB). In this mode, the control circuit 390 opens the feedback switches 332, 334, 352, and 354 (which disables the first feedback loop and the third feedback loop) and closes the feedback switches 336, 338, 356, and 358 (which enables the second feedback loop and the fourth feedback loop). In this mode, the resistances of the first tunable feedback resistor 320 and the second tunable feedback resistor 340 may be tuned to tune the gains of the second LNA 314 and the fourth LNA 318, respectively.

It is to be appreciated that the control circuit 390 is not limited to the exemplary modes discussed above and that the control circuit 390 may operate the receiver 300 in other modes using the feedback switches 332, 334, 336, 338, 352, 354, 356, and 358.

The receiver 300 also includes a routing and capacitor circuit 360 coupled between the outputs of the LNAs 312, 314, 316, and 318 and the mixers 180 and 185. The routing and capacitor circuit 360 is configured to provide signal routing and capacitance tuning between the LNAs 312, 314, 316, and 318 and the mixers 180 and 185. As discussed further below, the routing and capacitor circuit 360 reduces signal losses compared with the implementation shown in FIG. 2 by using parallel switches for signal routing and capacitor switching instead of using separate routing switches and capacitor switches coupled in series.

In the example in FIG. 3, the routing and capacitor circuit 360 has a first input 362, a second input 364, a third input 366, a fourth input 368, a first output 370, and a second output 372. The first input 362 is coupled to the output of the first LNA 312, the second input 364 is coupled to the output of the second LNA 314, the third input 366 is coupled to the output of the third LNA 316, and the fourth input 368 is coupled to the output of the fourth LNA 318. The first output 370 is selectively coupled to the first mixer 180 by switch 374 and the second output 372 is selectively coupled to the second mixer 185 by switch 376.

In certain aspects, the routing and capacitor circuit 360 is configured to selectively route the RF output signal of each of the LNAs 312, 314, 316, and 318 to the first mixer 180 or the second mixer 185 under the control of the control circuit 390. The routing and capacitor circuit 360 is also configured to provide capacitance tuning (e.g., for S11 tuning) between the LNAs 312, 314, 316, and 318 and the mixer 180 and 185.

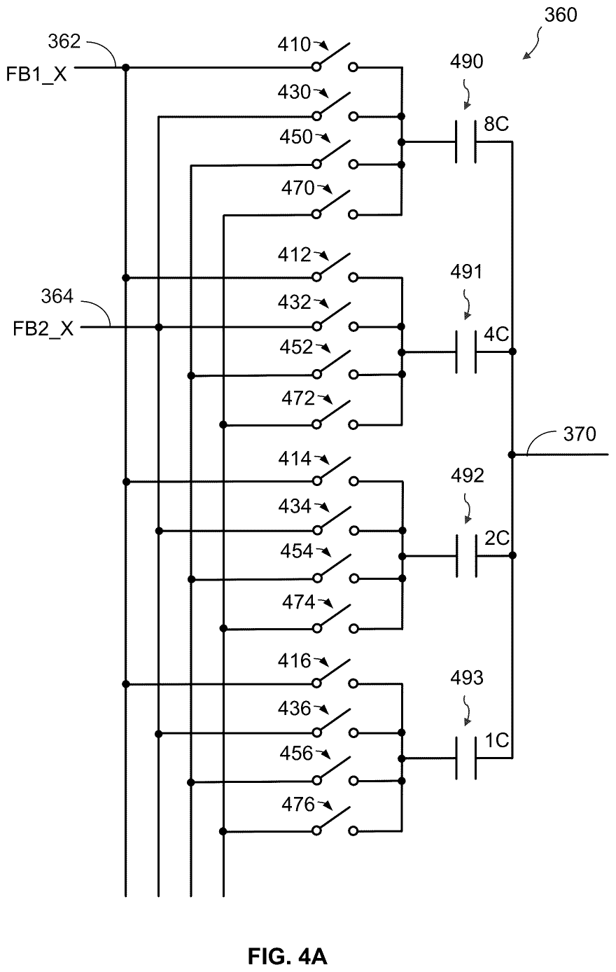

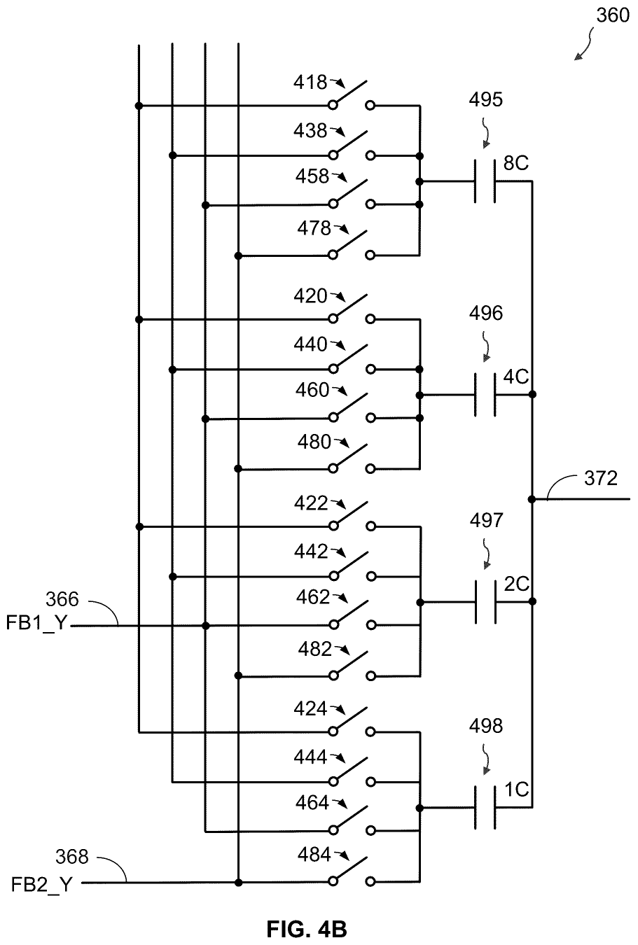

FIGS. 4A and 4B show an exemplary implementation of the routing and capacitor circuit 360 according to certain aspects. In this example, the routing and capacitor circuit 360 includes first capacitors 490, 491, 492, and 493 coupled to the first mixer 180 (shown in FIG. 3). The first capacitors 490, 491, 492, and 493 may include binary-weighted capacitors in which the capacitance of each of the first capacitors 490, 491, 492, and 493 is a respective power of two of a unit capacitance C.

As used herein, a “unit capacitance” may be the smallest capacitance of a capacitor in a set of capacitors. As used herein, “binary-weighted capacitors” are capacitors having capacitances that are different powers of two of the unit capacitance. Binary-weighted capacitors provide capacitance tuning with fine resolution over a wide tunable range by selecting different combinations of the binary-weighted capacitors using switches, as discussed further below. For an example of four binary-weighted capacitors, a combination of the binary-weighted capacitors may include any one of the binary-weighted capacitors, any two of the binary-weighted capacitors, any three of the binary-weighted capacitors, or all four of the binary-weighted capacitors.

In the example shown in FIG. 4A, the first capacitors 490, 491, 492, and 493 have capacitances of 8C, 4C, 2C, and 1C, respectively (i.e., 2³C, 2²C, 2¹C, and 2⁰C, respectively). However, it is to be appreciated that the present disclosure is not limited to this example. It is to be appreciated that each of the first capacitors 491, 492, and 493 may be implemented with two or more capacitors arranged in parallel where the capacitance of each of the two or more capacitors is approximately equal to C. Although four capacitors are shown in the example in FIG. 4A, it is to be appreciated that the first capacitors 490, 491, 492, and 493 may include a different number of capacitors in other implementations. In certain aspects, the first capacitors 490, 491, 492, and 493 include at least four binary-weighted capacitors.

The routing and capacitor circuit 360 also includes second capacitors 495, 496, 497, and 498 coupled to the second mixer 185 (shown in FIG. 3). The second capacitors 495, 496, 497, and 498 may include binary-weighted capacitors in which the capacitance of each of the second capacitors 495, 496, 497, and 498 is a respective power of two of the unit capacitance C.

In the example shown in FIG. 4B, the second capacitors 495, 496, 497, and 498 have capacitances of 8C, 4C, 2C, and 1C, respectively (i.e., 2³C, 2²C, 2¹C, and 2⁰C, respectively). However, it is to be appreciated that the present disclosure is not limited to this example. It is to be appreciated that each of the capacitors 496, 497, and 498 may be implemented with two or more capacitors arranged in parallel where the capacitance of each of the two or more capacitors is approximately equal to C. Although four capacitors are shown in the example in FIG. 4B, it is to be appreciated that the second capacitors 495, 496, 497, and 498 may include a different number of capacitors in other implementations. In certain aspects, the second capacitors 495, 496, 497, and 498 include at least four binary-weighted capacitors.

The routing and capacitor circuit 360 also includes first switches 410, 412, 414, and 416 (shown in FIG. 4A) and second switches 418, 420, 422, and 424 (shown in FIG. 4B). Each of the first switches 410, 412, 414, and 416 is coupled between the output of the first LNA 312 (shown in FIG. 3) and a respective one of the first capacitors 490, 491, 492, and 493. In the example in FIG. 4A, the switch 410 is coupled between the output of the first LNA 312 and the capacitor 490, the switch 412 is coupled between the output of the first LNA 312 and the capacitor 491, and so forth. Each of the switches may include a transistor, a transmission gate, or another type of switch.

Each of the second switches 418, 420, 422, and 424 is coupled between the output of the first LNA 312 (shown in FIG. 3) and a respective one of the second capacitors 495, 496, 497, and 498. In the example in FIG. 4B, the switch 418 is coupled between the output of the first LNA 312 and the capacitor 495, the switch 420 is coupled between the output of the first LNA 312 and the capacitor 496, and so forth.

In this example, the control circuit 390 (shown in FIG. 3) controls the on/off states of the first switches 410, 412, 414, and 416 and the on/off states of the second switches 418, 420, 422, and 424. The first switches 410, 412, 414, and 416 and the second switches 418, 420, 422, and 424 allow the control circuit 390 to simultaneously route the output RF signal of the first LNA 312 to the first mixer 180 and/or the second mixer 185 and tune the impedance matching capacitance (i.e., S11) for the first LNA 312.

For example, to route the output RF signal of the first LNA 312 to the first mixer 180, the control circuit 390 opens all of the second switches 418, 420, 422, and 424 and closes one or more of the first switches 410, 412, 414, and 416 depending on the desired capacitance between the output of the first LNA 312 and the first mixer 180. For example, the control circuit 390 may receive a first set of bits (e.g., a binary sequence of bits) corresponding to a first capacitance setting where the bit value of each of the bits in the first set of bits controls the on/off state of a respective one of the first switches 410, 412, 414, and 416. For example, a bit value of one may cause the control circuit 390 to close the respective one of the first switches 410, 412, 414, and 416 and a bit value of zero may cause the control circuit 390 to open the respective one of the first switches 410, 412, 414, and 416, or vice versa. In this example, the first set of bits sets the capacitance between the output of the first LNA 312 and the first mixer 380 by selecting which combination of the first capacitors 490, 491, 492, and 493 is coupled between the output of the first LNA 312 and the first mixer 380.

To route the output RF signal of the first LNA 312 to the second mixer 185, the control circuit 390 opens all of the first switches 410, 412, 414, and 416 and closes one or more of the second switches 418, 420, 422, and 424 depending on the desired capacitance between the output of the first LNA 312 and the second mixer 185. For example, the control circuit 390 may receive a second set of bits (e.g., a binary sequence of bits) corresponding to a second capacitance setting where the bit value of each of the bits in the second set of bits controls the on/off state of a respective one of the second switches 418, 420, 422, and 424. For example, a bit value of one may cause the control circuit 390 to close the respective one of the second switches 418, 420, 422, and 424 and a bit value of zero may cause the control circuit 390 to open the respective one of the second switches 418, 420, 422, and 424, or vice versa. In this example, the second set of bits sets the capacitance between the output of the first LNA 312 and the second mixer 385 by selecting which combination of the second capacitors 495, 496, 497, and 498 is coupled between the output of the first LNA 312 and the second mixer 385.

The routing and capacitor circuit 360 also includes third switches 430, 432, 434, and 436 (shown in FIG. 4A) and fourth switches 438, 440, 442, and 444 (shown in FIG. 4B). Each of the third switches 430, 432, 434, and 436 is coupled between the output of the second LNA 314 (shown in FIG. 3) and a respective one of the first capacitors 490, 491, 492, and 493. Each of the fourth switches 438, 440, 442, and 444 is coupled between the output of the second LNA 314 (shown in FIG. 3) and a respective one of the second capacitors 495, 496, 497, and 498.

In this example, the control circuit 390 (shown in FIG. 3) controls the on/off states of the third switches 430, 432, 434, and 436 and the on/off states of the fourth switches 438, 440, 442, and 444. The third switches 430, 432, 434, and 436 and the fourth switches 438, 440, 442, and 444 allow the control circuit 390 to simultaneously route the output RF signal of the second LNA 314 to the first mixer 180 and/or the second mixer 185 and tune the impedance matching capacitance (i.e., S11) for the second LNA 314.

For example, to route the output RF signal of the second LNA 314 to the first mixer 180, the control circuit 390 opens all of the fourth switches 438, 440, 442, and 444 and closes one or more of the third switches 430, 432, 434, and 436 depending on the desired capacitance between the output of the second LNA 314 and the first mixer 180. For example, the control circuit 390 may receive a third set of bits (e.g., a binary sequence of bits) corresponding to a third capacitance setting where the bit value of each of the bits in the third set of bits controls the on/off state of a respective one of the third switches 430, 432, 434, and 436. For example, a bit value of one may cause the control circuit 390 to close the respective one of the third switches 430, 432, 434, and 436 and a bit value of zero may cause the control circuit 390 to open the respective one of the third switches 430, 432, 434, and 436, or vice versa. In this example, the third set of bits sets the capacitance between the output of the second LNA 314 and the first mixer 380 by selecting which combination of the first capacitors 490, 491, 492, and 493 is coupled between the output of the second LNA 314 and the first mixer 380.

To route the output RF signal of the second LNA 314 to the second mixer 185, the control circuit 390 opens all of the third switches 430, 432, 434, and 436 and closes one or more of the fourth switches 438, 440, 442, and 444 depending on the desired capacitance between the output of the second LNA 314 and the second mixer 185. For example, the control circuit 390 may receive a fourth set of bits (e.g., a binary sequence of bits) corresponding to a fourth capacitance setting where the bit value of each of the bits in the fourth set of bits controls the on/off state of a respective one of the fourth switches 438, 440, 442, and 444. For example, a bit value of one may cause the control circuit 390 to close the respective one of the fourth switches 438, 440, 442, and 444 and a bit value of zero may cause the control circuit 390 to open the respective one of the fourth switches 438, 440, 442, and 444, or vice versa. In this example, the fourth set of bits sets the capacitance between the output of the second LNA 314 and the second mixer 385 by selecting which combination of the second capacitors 495, 496, 497, and 498 is coupled between the output of the second LNA 314 and the second mixer 385.

In this example, the routing and capacitor circuit 360 also includes fifth switches 450, 452, 454, and 456 (shown in FIG. 4A) and sixth switches 458, 460, 462, and 464 (shown in FIG. 4B). Each of the fifth switches 450, 452, 454, and 456 is coupled between the output of the third LNA 316 (shown in FIG. 3) and a respective one of the first capacitors 490, 491, 492, and 493. Each of the sixth switches 458, 460, 462, and 464 is coupled between the output of the third LNA 316 (shown in FIG. 3) and a respective one of the second capacitors 495, 496, 497, and 498.

In this example, the control circuit 390 (shown in FIG. 3) controls the on/off states of the fifth switches 450, 452, 454, and 456 and the on/off states of the sixth switches 458, 460, 462, and 464. The fifth switches 450, 452, 454, and 456 and the sixth switches 458, 460, 462, and 464 allow the control circuit 390 to simultaneously route the output RF signal of the third LNA 316 to the first mixer 180 and/or the second mixer 185 and tune the impedance matching capacitance (i.e., S11) for the third LNA 316.

For example, to route the output RF signal of the third LNA 316 to the first mixer 180, the control circuit 390 opens all of the sixth switches 458, 460, 462, and 464 and closes one or more of the fifth switches 450, 452, 454, and 456 depending on the desired capacitance between the output of the third LNA 316 and the first mixer 180. For example, the control circuit 390 may receive a fifth set of bits (e.g., a binary sequence of bits) corresponding to a fifth capacitance setting where the bit value of each of the bits in the fifth set of bits controls the on/off state of a respective one of the fifth switches 450, 452, 454, and 456. For example, a bit value of one may cause the control circuit 390 to close the respective one of the fifth switches 450, 452, 454, and 456 and a bit value of zero may cause the control circuit 390 to open the respective one of the fifth switches 450, 452, 454, and 456, or vice versa. In this example, the fifth set of bits sets the capacitance between the output of the third LNA 316 and the first mixer 380 by selecting which combination of the first capacitors 490, 491, 492, and 493 is coupled between the output of the third LNA 316 and the first mixer 380.

To route the output RF signal of the third LNA 316 to the second mixer 185, the control circuit 390 opens all of the fifth switches 450, 452, 454, and 456 and closes one or more of the sixth switches 458, 460, 462, and 464 depending on the desired capacitance between the output of the third LNA 316 and the second mixer 185. For example, the control circuit 390 may receive a sixth set of bits (e.g., a binary sequence of bits) corresponding to a sixth capacitance setting where the bit value of each of the bits in the sixth set of bits controls the on/off state of a respective one of the sixth switches 458, 460, 462, and 464. For example, a bit value of one may cause the control circuit 390 to close the respective one of the sixth switches 458, 460, 462, and 464 and a bit value of zero may cause the control circuit 390 to open the respective one of the sixth switches 458, 460, 462, and 464, or vice versa. In this example, the sixth set of bits sets the capacitance between the output of the third LNA 316 and the second mixer 385 by selecting which combination of the second capacitors 495, 496, 497, and 498 is coupled between the output of the third LNA 316 and the second mixer 385.

The routing and capacitor circuit 360 also includes seventh switches 470, 472, 474, and 476 (shown in FIG. 4A) and eighth switches 478, 480, 482, and 484 (shown in FIG. 4B). Each of the seventh switches 470, 472, 474, and 476 is coupled between the output of the fourth LNA 318 (shown in FIG. 3) and a respective one of the first capacitors 490, 491, 492, and 493. Each of the eighth switches 478, 480, 482, and 484 is coupled between the output of the fourth LNA 318 (shown in FIG. 3) and a respective one of the second capacitors 495, 496, 497, and 498.

In this example, the control circuit 390 (shown in FIG. 3) controls the on/off states of the seventh switches 470, 472, 474, and 476 and the on/off states of the eighth switches 478, 480, 482, and 484. The seventh switches 470, 472, 474, and 476 and the eighth switches 478, 480, 482, and 484 allow the control circuit 390 to simultaneously route the output RF signal of the fourth LNA 318 to the first mixer 180 and/or the second mixer 185 and tune the impedance matching capacitance (i.e., S11) for the fourth LNA 318.

For example, to route the output RF signal of the fourth LNA 318 to the first mixer 180, the control circuit 390 opens all of the eighth switches 478, 480, 482, and 484 and closes one or more of the seventh switches 470, 472, 474, and 476 depending on the desired capacitance between the output of the fourth LNA 318 and the first mixer 180. For example, the control circuit 390 may receive a seventh set of bits (e.g., a binary sequence of bits) corresponding to a seventh capacitance setting where the bit value of each of the bits in the seventh set of bits controls the on/off state of a respective one of the seventh switches 470, 472, 474, and 476. For example, a bit value of one may cause the control circuit 390 to close the respective one of the seventh switches 470, 472, 474, and 476 and a bit value of zero may cause the control circuit 390 to open the respective one of the seventh switches 470, 472, 474, and 476, or vice versa. In this example, the seventh set of bits sets the capacitance between the output of the fourth LNA 318 and the first mixer 380 by selecting which combination of the first capacitors 490, 491, 492, and 493 is coupled between the output of the fourth LNA 318 and the first mixer 380.

To route the output RF signal of the fourth LNA 318 to the second mixer 185, the control circuit 390 opens all of the seventh switches 470, 472, 474, and 476 and closes one or more of the eighth switches 478, 480, 482, and 484 depending on the desired capacitance between the output of the fourth LNA 318 and the second mixer 185. For example, the control circuit 390 may receive an eighth set of bits (e.g., a binary sequence of bits) corresponding to an eighth capacitance setting where the bit value of each of the bits in the eighth set of bits controls the on/off state of a respective one of the eighth switches 478, 480, 482, and 484. For example, a bit value of one may cause the control circuit 390 to close the respective one of the eighth switches 478, 480, 482, and 484 and a bit value of zero may cause the control circuit 390 to open the respective one of the eighth switches 478, 480, 482, and 484, or vice versa. In this example, the eighth set of bits sets the capacitance between the output of the fourth LNA 318 and the second mixer 385 by selecting which combination of the second capacitors 495, 496, 497, and 498 is coupled between the output of the fourth LNA 318 and the second mixer 385.

Thus, the switches in the routing and capacitor circuit 360 allow the control circuit 390 to control signal routing (i.e., path selection) and capacitor switching (i.e., capacitance tuning) for the LNAs 312, 314, 316, and 318 to support different modes of operation. Because the switches in the routing and capacitor circuit 360 perform both signal routing and capacitor switching, the switches eliminate the additional signal losses associated with coupling the routing switches and capacitor switches shown in FIG. 2 in series, thereby reducing the total signal losses in the receiver 300.

In the example shown in FIGS. 4A and 4B, the first capacitors 490, 491, 492, and 493 and the second capacitors 495, 496, 497, and 498 are shared by the first frequency band paths (i.e., output signal paths of the first LNA 312 and the third LNA 316) and the second frequency band paths (i.e., output signal paths of the second LNA 314 and the fourth LNA 318). This reduces the number of capacitors compared with the example in FIG. 2, which reduces the area of the receiver 300.

When the receiver 300 operates in the first frequency band, the control circuit 390 may use the first switches 410, 412, 414, and 416, the second switches 418, 420, 422, and 424, the fifth switches 450, 452, 454, and 456, and the sixth switches 458, 460, 462, and 464 to control the signal routing and capacitor switching for the first LNA 312 and the third LNA 316. For example, to route the output RF signal of the first LNA 312 to the first mixer 180 and route the output RF signal of the third LNA 316 to the second mixer 185, the control circuit 390 opens all of the second switches 418, 420, 422, and 424, opens all of the fifth switches 450, 452, 454, and 456, closes one or more of the first switches 410, 412, 414, and 416 based on the first set of bits, and closes one or more of the sixth switches 458, 460, 462, and 464 based on the sixth set of bits. To route the output RF signal of the first LNA 312 to the second mixer 185 and route the output RF signal of the third LNA 316 to the first mixer 180, the control circuit 390 opens all of the first switches 410, 412, 414, and 416, opens all of the sixth switches 458, 460, 462, and 464, closes one or more of the second switches 418, 420, 422, and 424 based on the second set of bits, and closes one or more of the fifth switches 450, 452, 454, and 456 based on the fifth set of bits. It is to be appreciated that the control circuit 390 may also route the output RF signals of the first LNA 312 and the third LNA 316 to the same mixer (i.e., the first mixer 180 or the second mixer 185).

When the receiver 300 operates in the second frequency band, the control circuit 390 may use the third switches 430, 432, 434, and 436, the fourth switches 438, 440, 442, and 444, the seventh switches 470, 472, 474, and 476, and the eighth switches 478, 480, 482, and 484 to control the signal routing and capacitor switching for the second LNA 314 and the fourth LNA 318. For example, to route the output RF signal of the second LNA 314 to the first mixer 180 and route the output RF signal of the fourth LNA 318 to the second mixer 185, the control circuit 390 opens all of the fourth switches 438, 440, 442, and 444, opens all of the seventh switches 470, 472, 474, and 476, closes one or more of the third switches 430, 432, 434, and 436 based on the third set of bits, and closes one or more of the eighth switches 478, 480, 482, and 484 based on the eighth set of bits. To route the output RF signal of the second LNA 314 to the second mixer 185 and route the output RF signal of the fourth LNA 318 to the first mixer 180, the control circuit 390 opens all of the third switches 430, 432, 434, and 436, opens all of the eighth switches 478, 480, 482, and 484, closes one or more of the fourth switches 438, 440, 442, and 444 based on the fourth set of bits, and closes one or more of the seventh switches 470, 472, 474, and 476 based on the seventh set of bits. It is to be appreciated that the control circuit 390 may also route the output RF signals of the second LNA 314 and the fourth LNA 318 to the same mixer (i.e., the first mixer 180 or the second mixer 185).

In certain aspects, in a first mode, the control circuit 390 is configured to close one or more of the first switches 410, 412, 414, and 416 based on the first set of bits and/or close one or more of the second switches 418, 420, 422, and 424 based on the second set of bits, open all of the third switches 430, 432, 434, and 436, and open all of the fourth switches 438, 440, 442, and 444. In this mode, the output of the first LNA 312 is routed to the first mixer 380 and/or the second mixer 385 for operation in the first frequency band. Also, in this mode, the control circuit 390 may also be configured to close one or more of the fifth switches 450, 452, 454, and 456 based on the fifth set of bits and/or close one or more of the sixth switches 458, 460, 462, and 464 based on the sixth set of bits, open all of the seventh switches 470, 472, 474, and 476, and open all of the eighth switches 478, 480, 482, and 484. In this mode, the output of the third LNA 316 is routed to the first mixer 380 and/or the second mixer 385 for operation in the first frequency band.

In a second mode, the control circuit 390 is configured to close one or more of the third switches 430, 432, 434, and 436 based on the third set of bits and/or close one or more of the fourth switches 438, 440, 442, and 444 based on the fourth set of bits, open all of the first switches 410, 412, 414, and 416, and open all of the second switches 418, 420, 422, and 424. In this mode, the output of the second LNA 314 is routed to the first mixer 380 and/or the second mixer 385 for operation in the second frequency band. Also, in this mode, the control circuit 390 may also be configured to close one or more of the seventh switches 470, 472, 474, and 476 based on the seventh set of bits and/or close one or more of the eighth switches 478, 480, 482, and 484 based on the eighth set of bits, open all of the fifth switches 450, 452, 454, and 456, and open all of the sixth switches 458, 460, 462, and 464. In this mode, the output of the fourth LNA 318 is routed to the first mixer 380 and/or the second mixer 385 for operation in the second frequency band.

It is to be appreciated that the receiver 300 is not limited to the number of LNAs 312, 314, 316, and 318 shown in the example in FIG. 3 and that the receiver 300 may include a smaller number of LNAs or a larger number of LNAs in other implementations.

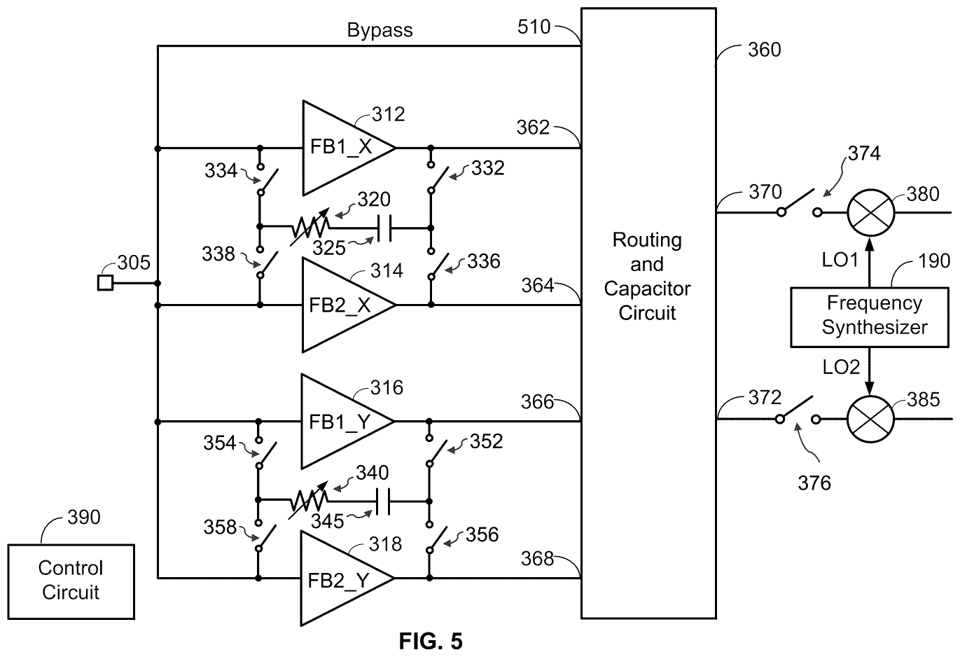

In certain aspects, the receiver 300 includes a bypass path that bypasses the LNAs 312, 314, 316, and 318, as shown in FIG. 5. For example, the bypass path may be used to bypass the LNAs 312, 314, 316, and 318 when a received RF signal has a high signal strength (e.g., the source of the RF signal is located near the wireless device). In the example in FIG. 5, the bypass path is coupled between the input port 305 and a fifth input 510 of the routing and capacitor circuit 360.

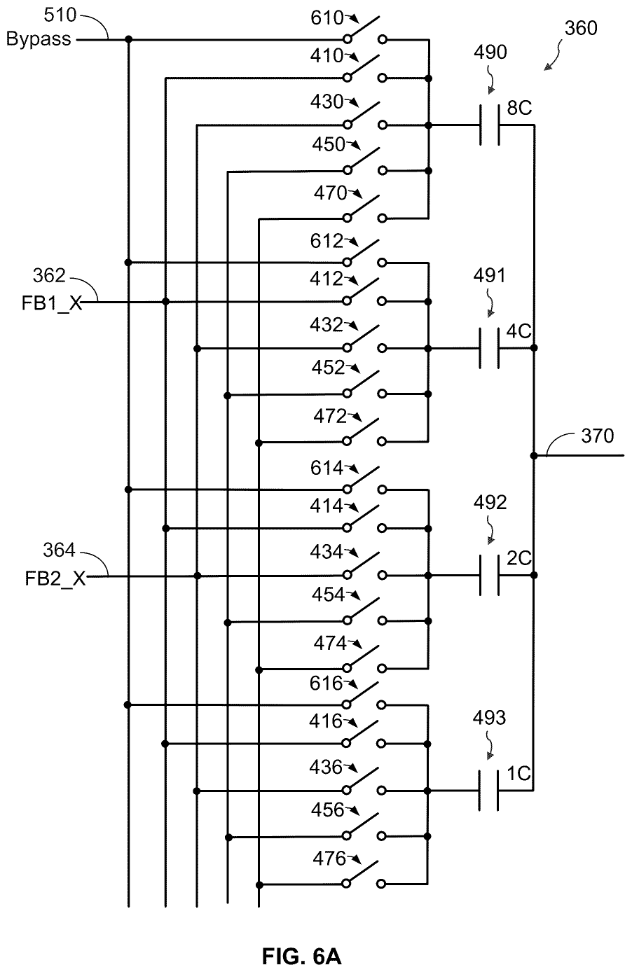

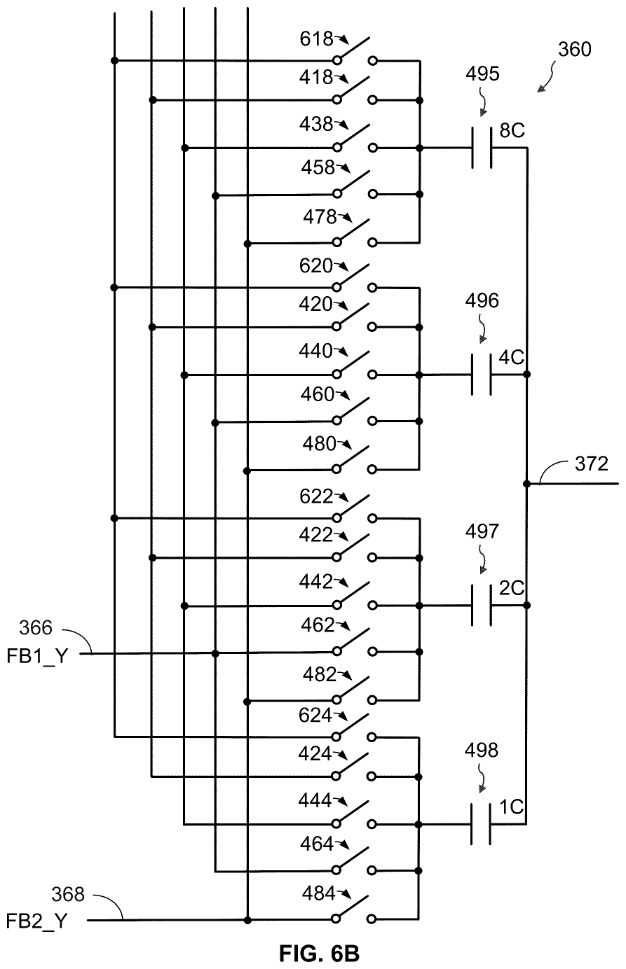

FIGS. 6A and 6B show an exemplary implementation in which the routing and capacitor circuit 360 provides signal routing and capacitor switching for the bypass path. In this example, the routing and capacitor circuit 360 also includes ninth switches 610, 612, 614, and 616 (shown in FIG. 6A) and tenth switches 618, 620, 622, and 624 (shown in FIG. 6B). Each of the ninth switches 610, 612, 614, and 616 is coupled between the bypass path (shown in FIG. 5) and a respective one of the first capacitors 490, 491, 492, and 493. Each of the tenth switches 618, 620, 622, and 624 is coupled between the bypass path (shown in FIG. 5) and a respective one of the second capacitors 495, 496, 497, and 498.

In this example, the control circuit 390 (shown in FIG. 5) controls the on/off states of the ninth switches 610, 612, 614, and 616 and the on/off states of the tenth switches 618, 620, 622, and 624. The ninth switches 610, 612, 614, and 616 and the tenth switches 618, 620, 622, and 624 allow the control circuit 390 to simultaneously route the RF signal on the bypass path to the first mixer 180 and/or the second mixer 185 and tune the impedance matching capacitance (i.e., S11) for the bypass path.

For example, to route the RF signal on the bypass path to the first mixer 180, the control circuit 390 opens all of the tenth switches 618, 620, 622, and 624 and closes one or more of the ninth switches 610, 612, 614, and 616 depending on the desired capacitance between the bypass path and the first mixer 180. For example, the control circuit 390 may receive a ninth set of bits (e.g., a binary sequence of bits) corresponding to a ninth capacitance setting where the bit value of each of the bits in the ninth set of bits controls the on/off state of a respective one of the ninth switches 610, 612, 614, and 616. For example, a bit value of one may cause the control circuit 390 to close the respective one of the ninth switches 610, 612, 614, and 616 and a bit value of zero may cause the control circuit 390 to open the respective one of the ninth switches 610, 612, 614, and 616, or vice versa.

To route the output RF signal on the bypass path to the second mixer 185, the control circuit 390 opens all of the ninth switches 610, 612, 614, and 616 and closes one or more of the tenth switches 618, 620, 622, and 624 depending on the desired capacitance between the bypass path and the second mixer 185. For example, the control circuit 390 may receive a tenth set of bits (e.g., a binary sequence of bits) corresponding to a tenth capacitance setting where the bit value of each of the bits in the tenth set of bits controls the on/off state of a respective one of the tenth switches 618, 620, 622, and 624. For example, a bit value of one may cause the control circuit 390 to close the respective one of the tenth switches 618, 620, 622, and 624 and a bit value of zero may cause the control circuit 390 to open the respective one of the tenth switches 618, 620, 622, and 624, or vice versa.

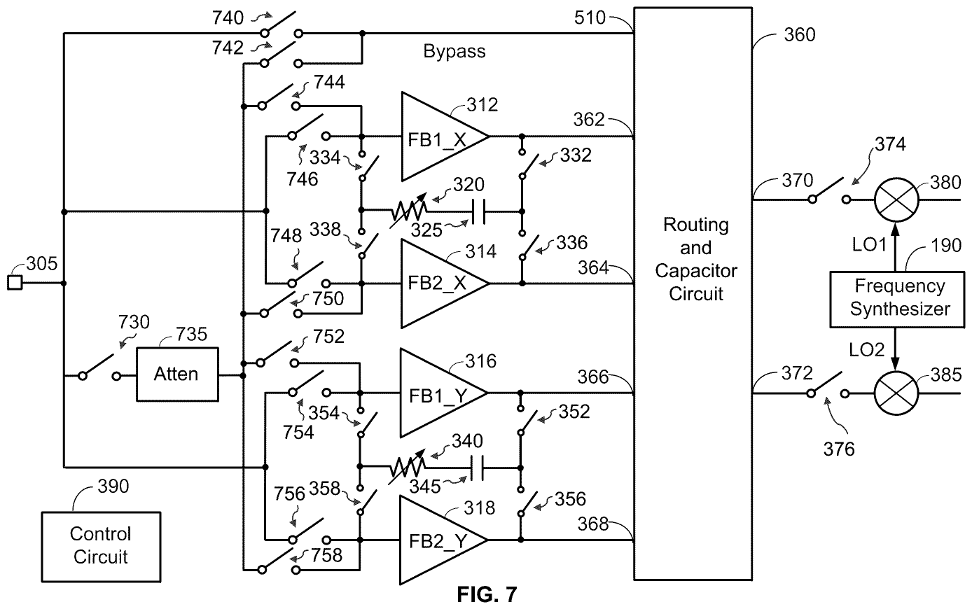

In certain aspects, the receiver 300 also includes an attenuator 735, as shown in FIG. 7. The attenuator 735 may be used, for example, to attenuate an RF signal with a high signal strength (e.g., to prevent one or more of the LNAs 312, 314, 316, and 318 from saturating due to the high signal strength). In the example in FIG. 7, the receiver 300 includes attenuator switches 730, 740, 742, 744, 746, 748, 750, 752, 754, 756, and 758 for selectively coupling the attenuator 735 to the bypass path and the inputs of the LNAs 312, 314, 316, and 318.

In this example, the switch 730 is coupled between the input port 305 and the attenuator 735. The switch 740 is coupled between the input port 305 and the bypass path and the switch 742 is coupled between the attenuator 735 and the bypass path. The switch 744 is coupled between the attenuator 735 and the input of the first LNA 312 and the switch 746 is coupled between the input port 305 and the input of the first LNA 312. The switch 750 is coupled between the attenuator 735 and the input of the second LNA 314 and the switch 748 is coupled between the input port 305 and the input of the second LNA 314. The switch 752 is coupled between the attenuator 735 and the input of the third LNA 316 and the switch 754 is coupled between the input port 305 and the input of the third LNA 316. The switch 758 is coupled between the attenuator 735 and the input of the fourth LNA 318 and the switch 756 is coupled between the input port 305 and the input of the fourth LNA 318.

In this example, the control circuit 390 controls the on/off states of the attenuator switches 730, 740, 742, 744, 746, 748, 750, 752, 754, 756, and 758 for selectively coupling the attenuator 735 to the bypass path and the inputs of the LNAs 312, 314, 316, and 318. For example, to couple the bypass path to the attenuator 735, the control circuit 390 closes the switch 742 and opens the switch 740. When the attenuator 735 is not used for the bypass path, the control circuit 390 opens the switch 742 and closes the switch 740. The control circuit 390 may open both switches 740 and 742 when the RF signal is not being routed through the bypass path.

To couple the input of the first LNA 312 to the attenuator 735, the control circuit 390 closes the switch 744 and opens the switch 746. When the attenuator 735 is not used for the first LNA 312, the control circuit 390 opens the switch 744 and closes the switch 746. The control circuit 390 may open both switches 744 and 746 when the RF signal is not being routed to the first LNA 312.

To couple the input of the second LNA 314 to the attenuator 735, the control circuit 390 closes the switch 750 and opens the switch 748. When the attenuator 735 is not used for the second LNA 314, the control circuit 390 opens the switch 750 and closes the switch 748. The control circuit 390 may open both switches 748 and 750 when the RF signal is not being routed to the second LNA 314.

To couple the input of the third LNA 316 to the attenuator 735, the control circuit 390 closes the switch 752 and opens the switch 754. When the attenuator 735 is not used for the third LNA 316, the control circuit 390 opens the switch 752 and closes the switch 754. The control circuit 390 may open both switches 752 and 754 when the RF signal is not being routed to the third LNA 316.

To couple the input of the fourth LNA 318 to the attenuator 735, the control circuit 390 closes the switch 758 and opens the switch 756. When the attenuator 735 is not used for the fourth LNA 318, the control circuit 390 opens the switch 758 and closes the switch 756. The control circuit 390 may open both switches 754 and 756 when the RF signal is not being routed to the fourth LNA 318.

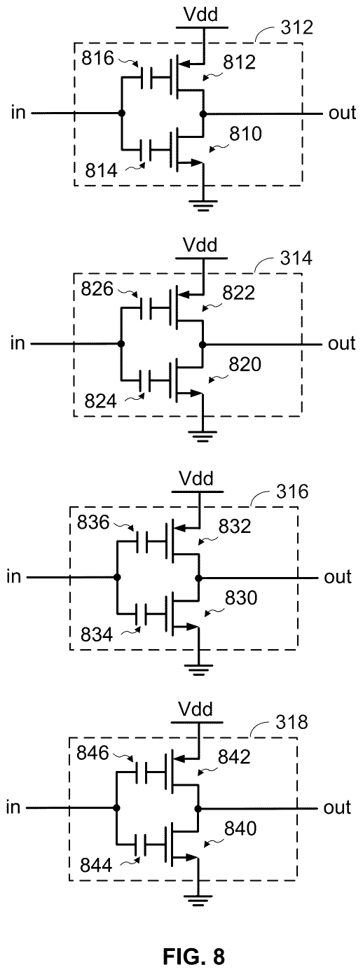

FIG. 8 shows an exemplary implementation of the LNAs 312, 314, 316, and 318. In this example, the first LNA 312 includes a first transistor 810 (e.g., an n-type field effect transistor (NFET)), a second transistor 812 (e.g., a p-type field effect transistor (PFET)), a first coupling capacitor 814, and a second coupling capacitor 816. In this example, the first transistor 810 and the second transistor 812 are complementary transistors configured to form an inverting amplifier. The source of the first transistor 810 is coupled to the supply rail, the drains of the first and second transistors 810 and 812 are coupled to the output of the first LNA 312, and the source of the second transistor 812 is coupled to ground (or some reference potential). The first coupling capacitor 814 is coupled between the input of the first LNA 312 and the gate of the first transistor 810, and the second coupling capacitor 816 is coupled between the input of the first LNA 312 and the gate of the second transistor 812. It is to be appreciated that the first LNA 312 may include one or more additional components not shown in FIG. 8.

The second LNA 314 includes a first transistor 820 (e.g., an NFET), a second transistor 822 (e.g., a PFET), a first coupling capacitor 824, and a second coupling capacitor 826. In this example, the first transistor 820 and the second transistor 822 are complementary transistors configured to form an inverting amplifier. The source of the first transistor 820 is coupled to the supply rail, the drains of the first and second transistors 820 and 822 are coupled to the output of the second LNA 314, and the source of the second transistor 822 is coupled to ground (or some reference potential). The first coupling capacitor 824 is coupled between the input of the second LNA 314 and the gate of the first transistor 820, and the second coupling capacitor 826 is coupled between the input of the second LNA 314 and the gate of the second transistor 822. It is to be appreciated that the second LNA 314 may include one or more additional components not shown in FIG. 8.

The third LNA 316 includes a first transistor 830 (e.g., an NFET), a second transistor 832 (e.g., a PFET), a first coupling capacitor 834, and a second coupling capacitor 836. In this example, the first transistor 830 and the second transistor 832 are complementary transistors configured to form an inverting amplifier. The source of the first transistor 830 is coupled to the supply rail, the drains of the first and second transistors 830 and 832 are coupled to the output of the third LNA 316, and the source of the second transistor 832 is coupled to ground (or some reference potential). The first coupling capacitor 834 is coupled between the input of the third LNA 316 and the gate of the first transistor 830, and the second coupling capacitor 836 is coupled between the input of the third LNA 316 and the gate of the second transistor 832. It is to be appreciated that the third LNA 316 may include one or more additional components not shown in FIG. 8.

The fourth LNA 318 includes a first transistor 840 (e.g., an NFET), a second transistor 842 (e.g., a PFET), a first coupling capacitor 844, and a second coupling capacitor 846. In this example, the first transistor 840 and the second transistor 842 are complementary transistors configured to form an inverting amplifier. The source of the first transistor 840 is coupled to the supply rail, the drains of the first and second transistors 840 and 842 are coupled to the output of the fourth LNA 318, and the source of the second transistor 842 is coupled to ground (or some reference potential). The first coupling capacitor 844 is coupled between the input of the fourth LNA 318 and the gate of the first transistor 840, and the second coupling capacitor 846 is coupled between the input of the fourth LNA 318 and the gate of the second transistor 842. It is to be appreciated that the fourth LNA 318 may include one or more additional components not shown in FIG. 8.

In certain aspects, each of the transistors 810 and 830 (e.g., NFETs) in the first LNA 312 and the third LNA 316 may have the first gate length (e.g., 36 nm) and each of the transistors 820 and 840 (e.g., NFETs) in the second LNA 314 and the fourth LNA 318 may have the second gate length (e.g., 20 nm) discussed above. Also, each of the transistors 812 and 832 (e.g., PFETs) in the first LNA 312 and the third LNA 316 may have the first gate length (e.g., 36 nm) and each of the transistors 822 and 842 (e.g., PFETs) in the second LNA 314 and the fourth LNA 318 may have the second gate length (e.g., 20 nm) discussed above. However, it is to be appreciated that the present disclosure is not limited to this example.

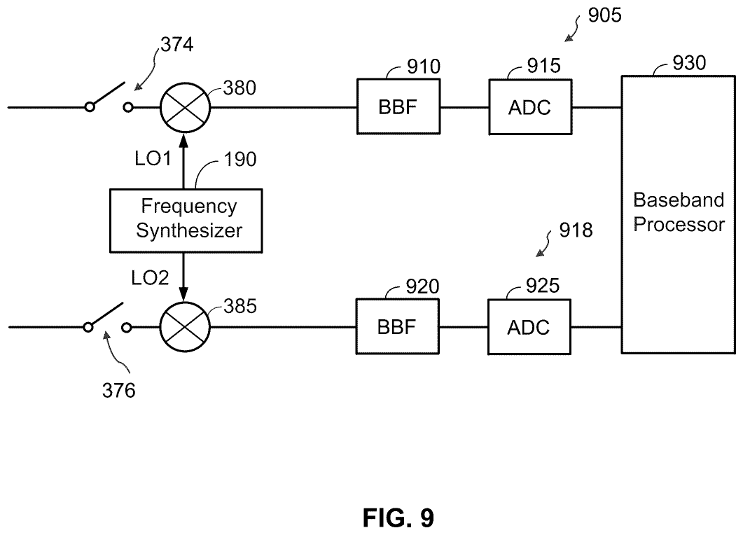

FIG. 9 shows an example of a first receive chain 905 coupled to the output of the first mixer 380 and a second receive chain 918 coupled to the output of the second mixer 385. The first receive chain 905 includes a first baseband filter 910 and a first ADC 915 in which the first baseband filter 910 is coupled between the first mixer 380 and the first ADC 915. In this example, the first mixer 380 is configured to frequency downconvert one or more RF signals from one or more of the LNAs 312, 314, 316, and 318 into one or more baseband signals and output the one or more baseband signals to the first baseband filter 910. The first baseband filter 910 is configured to the pass the one or more baseband signals to the first ADC 915 while filtering out out-of-band signals. The first ADC 915 is configured to convert the one or more baseband signals into a digital signal and output the digital signal to a baseband processor 930, which processes the digital signal in the digital domain (e.g., to recover data and/or control information from the digital signal). The processing performed by the baseband processor 930 may include demodulation, decoding, etc. The baseband processor 930 may be implemented with a digital signal processor (DSP) and/or another type of processor.

It is to be appreciated that the first receive chain 905 is not limited to the first baseband filter 910 and the first ADC 915 and that the first receive chain 905 may include one or more additional components not shown in FIG. 9. For example, in some implementations, the first mixer 380 may be configured to frequency downconvert one or more RF signals from one or more of the LNAs 312, 314, 316, and 318 into one or more intermediate frequency (IF) signals. In these implementations, the first receive chain 905 may include an additional mixer (not shown) between the first mixer 380 and the first baseband filter 910 to frequency downconvert the one or more IF signals into one or more baseband signals.

The second receive chain 918 includes a second baseband filter 920 and a second ADC 925 in which the second baseband filter 920 is coupled between the second mixer 385 and the second ADC 925. In this example, the second mixer 385 is configured to frequency downconvert one or more RF signals from one or more of the LNAs 312, 314, 316, and 318 into one or more baseband signals and output the one or more baseband signals to the second baseband filter 920. The second baseband filter 920 is configured to the pass the one or more baseband signals to the second ADC 925 while filtering out out-of-band signals. The second ADC 925 is configured to convert the one or more baseband signals into a digital signal and output the digital signal to the baseband processor 930, which processes the digital signal in the digital domain (e.g., to recover data and/or control information from the digital signal). The processing performed by the baseband processor 930 may include demodulation, decoding, etc.

It is to be appreciated that the second receive chain 918 is not limited to the second baseband filter 920 and the second ADC 925 and that the second receive chain 918 may include one or more additional components not shown in FIG. 9. For example, in some implementations, the second mixer 385 may be configured to frequency downconvert one or more RF signals from one or more of the LNAs 312, 314, 316, and 318 into one or more IF signals. In these implementations, the second receive chain 918 may include an additional mixer (not shown) between the second mixer 385 and the second baseband filter 920 to frequency downconvert the one or more IF signals into one or more baseband signals.

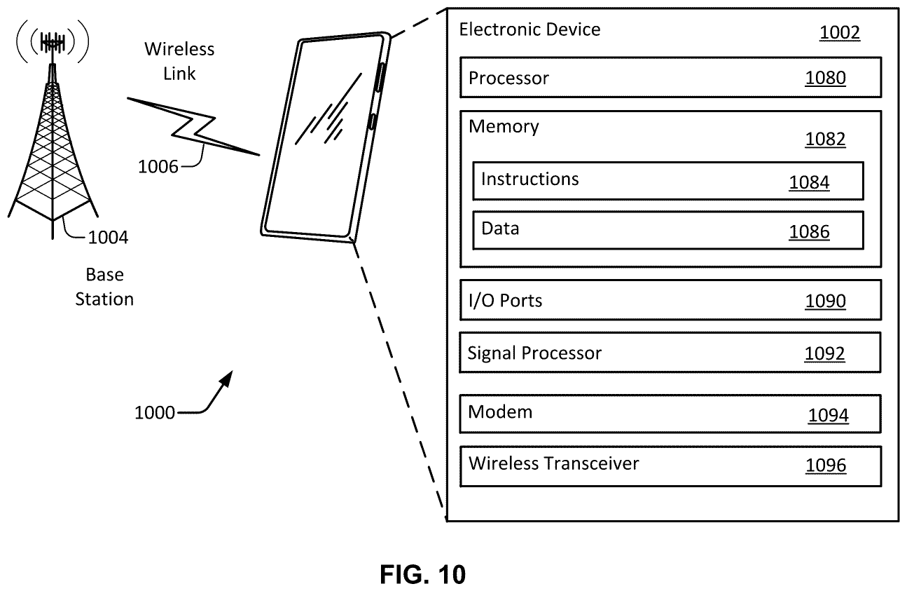

FIG. 10 is a diagram of an environment 1000 that includes a wireless device 1002 and a base station 1004. In the environment 1000, the wireless device 1002 communicates with the base station 1004 via a wireless link 1006. As shown, the wireless device 1002 is depicted as a smart phone. However, it is to be understood that the wireless device 1002 may be implemented as any suitable wireless device, such as a cellular base station, a broadband router, an access point, a cellular or mobile phone, a gaming device, a navigation device, a media device, a laptop computer, a desktop computer, a tablet computer, a server computer, a network-attached storage (NAS) device, a smart appliance, a vehicle-based communication system, an Internet of Things (IoT) device, a sensor or security device, an asset tracker, and so forth.

The base station 1004 communicates with the wireless device 1002 via the wireless link 1006, which may be implemented as any suitable type of wireless link. Although depicted as a base station tower of a cellular radio network, the base station 1004 may represent or be implemented as another device, such as a satellite, a terrestrial broadcast tower, an access point, a peer-to-peer device, a mesh network node, and so forth. The wireless link 1006 may include a downlink of data and/or control information communicated from the base station 1004 to the wireless device 1002 and an uplink of other data and/or control information communicated from the wireless device 1002 to the base station 1004. The wireless link 1006 may be implemented using any suitable communication protocol or standard, such as 3rd Generation Partnership Project Long-Term Evolution (3GPP LTE, 3GPP NR 5G), IEEE 1002.99, IEEE 1002.99, Bluetooth™, and so forth.

The wireless device 1002 includes a processor 1080 and a memory 1082. The memory 1082 may be or form a portion of a computer readable storage medium. The processor 1080 may include any type of processor, such as an application processor or a multi-core processor, that is configured to execute processor-executable instructions stored in the memory 1082. The memory 1082 may include any suitable type of data storage media, such as a volatile memory (e.g., random access memory (RAM)), a non-volatile memory (e.g., Flash memory), an optical media, a magnetic media (e.g., disk or tape), or any combination thereof. In the context of this disclosure, the memory 1082 may store instructions 1084, data 1086, and other information of the wireless device 1002.

The wireless device 1002 may also include input/output (I/O) ports 1090. The I/O ports 1090 enable data exchanges or interaction with other devices, networks, or users or between components of the wireless device 1002.

The wireless device 1002 may further include a signal processor (SP) 1092 (e.g., such as a digital signal processor (DSP)). The signal processor 1092 may function similar to the processor 1080 and may be capable of executing instructions and/or processing information in conjunction with the memory 1082.

For communication purposes, the wireless device 1002 also includes a modem 1094 (e.g., the baseband processor 930), a wireless transceiver 1096, and one or more antennas (e.g., the antenna 308). The wireless transceiver 1096 may include the receiver 300, the first receive chain 905, and/or the second receive chain 918 discussed above. The wireless transceiver 1096 provides connectivity to respective networks (e.g., the base station 1004) and other wireless devices connected therewith using RF signals. The wireless transceiver 1096 may facilitate communication over any suitable type of wireless network, such as a wireless local area network (LAN) (WLAN), a peer-to-peer (P2P) network, a mesh network, a cellular network, a wireless wide area network (WWAN), a navigational network (e.g., the Global Positioning System (GPS) of North America or another Global Navigation Satellite System (GNSS)), and/or a wireless personal area network (WPAN).

The control circuit 390 may be implemented with a general-purpose processor, a digital signal processor (DSP), an application specific integrated circuit (ASIC), a field programmable gate array (FPGA) or other programmable logic device, discrete hardware components (e.g., logic gates), or any combination thereof designed to perform the functions described herein. A processor may perform the functions described herein by executing software comprising code for performing the functions. The software may be stored on a computer-readable storage medium, such as a RAM, a ROM, an EEPROM, an optical disk, and/or a magnetic disk.

Implementation examples are described in the following numbered clauses:
1. A system for wireless communications, comprising:
   a first low-noise amplifier (LNA);
   a second LNA;
   first capacitors;
   second capacitors;
   first switches, wherein each of the first switches is coupled between an output of the first LNA and a respective one of the first capacitors;
   second switches, wherein each of the second switches is coupled between the output of the first LNA and a respective one of the second capacitors;
   third switches, wherein each of the third switches is coupled between an output of the second LNA and a respective one of the first capacitors;
   fourth switches, wherein each of the fourth switches is coupled between the output of the second LNA and a respective one of the second capacitors;
   a first mixer coupled to the first capacitors; and
   a second mixer coupled to the second capacitors.
2. The system of clause 1, further comprising a control circuit configured to:
   in a first mode, open all of the second switches and close one or more of the first switches based on a first set of bits; and
   in a second mode, open all of the first switches and close one or more of the second switches based on a second set of bits.
3. The system of clause 1 or 2, wherein the first capacitors include first binary-weighted capacitors and the second capacitors include second binary-weighted capacitors.
4. The system of any one of clauses 1 to 3, wherein the first LNA is configured to amplify radio frequency (RF) signals in a first frequency band and the second LNA is configured to amplify RF signals in a second frequency band different from the first frequency band.
5. The system of clause 4, wherein the first frequency band is below one GHz and the second frequency band is above one GHz.
6. The system of any one of clauses 1 to 5, further comprising a frequency synthesizer coupled to the first mixer and the second mixer, wherein the frequency synthesizer is configured to output a first local oscillator signal to the first mixer and output a second local oscillator signal to the second mixer.
7. The system of clause 6, wherein the first local oscillator signal and the second local oscillator signal have different frequencies.
8. The system of any one of clauses 1 to 7, wherein the first LNA comprises a first transistor having a first gate length, the second LNA comprises a second transistor having a second gate length, and the first gate length is longer than the second gate length.
9. The system of any one of clauses 1 to 8, further comprising:
   a feedback resistor;
   first feedback switches configured to selectively couple the feedback resistor between the output of the first LNA and an input of the first LNA; and
   second feedback switches configured to selectively couple the feedback resistor between the output of the second LNA and an input of the second LNA.
10. The system of clause 9, further comprising a control circuit configured to:
   in a first mode, close the first feedback switches and open the second feedback switches; and
   in a second mode, open the first feedback switches and close the second feedback switches.
11. The system of any one of clauses 1 to 10, further comprising a control circuit configured to:
   in a first mode, close one or more of the first switches based on a first set of bits and/or close one or more of the second switches based on a second set of bits, open all of the third switches, and open all of the fourth switches; and
   in a second mode, close one or more of the third switches based on a third set of bits and/or close one or more of the fourth switches based on a fourth set of bits, open all of the first switches, and open all of the second switches.
12. The system of any one of clauses 1 to 11, further comprising:
   a bypass path bypassing the first LNA and the second LNA;
   fifth switches, wherein each of the fifth switches is coupled between the bypass path and a respective one of the first capacitors; and
   sixth switches, wherein each of the sixth switches is coupled between the bypass path and a respective one of the second capacitors.
13. The system of any one of clauses 1 to 12, further comprising:
   a third LNA;
   fifth switches, wherein each of the fifth switches is coupled between an output of the third LNA and a respective one of the first capacitors; and
   sixth switches, wherein each of the sixth switches is coupled between the output of the third LNA and a respective one of the second capacitors.
14. The system of clause 13, further comprising:
   a fourth LNA;
      seventh switches, wherein each of the seventh switches is coupled between an output of the fourth LNA and a respective one of the first capacitors; and
      eighth switches, wherein each of the eighth switches is coupled between the output of the fourth LNA and a respective one of the second capacitors.
15. The system of clause 14, wherein each of the first LNA and the third LNA is configured to amplify radio frequency (RF) signals in a first frequency band and each of the second LNA and the fourth LNA is configured to amplify RF signals in a second frequency band different from the first frequency band.
16. The system of clause 15, wherein the first frequency band is below one GHz and the second frequency band is above one GHz.
17. The system of any one of clauses 1 to 16, further comprising:
   a first analog-to digital converter (ADC); and
   a first filter coupled between the first mixer and the first ADC.
18. The system of clause 17, further comprising:
   a second ADC; and
   a second filter coupled between the second mixer and the second ADC.
19. The system of any one of clauses 1 to 18 further comprising an antenna coupled to an input of the first LNA.
20. The system of clause 19, wherein the antenna is coupled to an input of the second LNA.
21. A system for wireless communications, comprising:
   a first low-noise amplifier (LNA);
   a second LNA;
   capacitors;
   first switches, wherein each of the first switches is coupled between an output of the first LNA and a respective one of the capacitors;
   second switches, wherein each of the second switches is coupled between an output of the second LNA and a respective one of the capacitors; and
   a mixer coupled to the capacitors.
22. The system of clause 21, further including a control circuit configured to:
   in a first mode, open all of the second switches and close one or more of the first switches based on a first set of bits; and
   in a second mode, open all of the first switches and close one or more of the second switches based on a second set of bits.
23. The system of clause 21 or 22, wherein the capacitors comprise binary-weighted capacitors.
24. The system of any one of clauses 21 to 23, wherein the first LNA is configured to amplify radio frequency (RF) signals in a first frequency band and the second LNA is configured to amplify RF signals in a second frequency band different from the first frequency band.
25. The system of clause 24, wherein the first frequency band is below one GHz and the second frequency band is above one GHz.
26. The system of any one of clauses 21 to 25, wherein the first LNA comprises a first transistor having a first gate length, the second LNA comprises a second transistor having a second gate length, and the first gate length is longer than the second gate length.
27. The system of any one of clauses 21 to 26, further comprising
   a third LNA;
   a fourth LNA;
   third switches, wherein each of the third switches is coupled between an output of the third LNA and a respective one of the capacitors; and
   fourth switches, wherein each of the fourth switches is coupled between an output of the fourth LNA and a respective one of the capacitors.
28. The system of any one of clauses 21 to 27, further comprising: an analog-to digital converter (ADC); and a filter coupled between the mixer and the ADC.
29. The system any one of clauses 21 to 28 further comprising an antenna coupled to an input of the first LNA.
30. The system of clause 29, wherein the antenna is coupled to an input of the second LNA.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect electrical coupling between two structures. A and/or B means A, B, or A and B. As used herein, “approximately” means within a range of 90 percent to 110 percent of the stated value.

Any reference to an element herein using a designation such as “first,” “second,” and so forth does not generally limit the quantity or order of those elements. Rather, these designations are used herein as a convenient way of distinguishing between two or more elements or instances of an element. Thus, a reference to first and second elements does not mean that only two elements can be employed, or that the first element must precede the second element.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples described herein but is to be accorded the widest scope consistent with the principles and novel features disclosed herein.

What is claimed is:

1. A system for wireless communications, comprising:
a first low-noise amplifier (LNA);
a second LNA;
first capacitors;
second capacitors;
first switches, wherein each of the first switches is coupled between an output of the first LNA and a respective one of the first capacitors;
second switches, wherein each of the second switches is coupled between the output of the first LNA and a respective one of the second capacitors;
third switches, wherein each of the third switches is coupled between an output of the second LNA and a respective one of the first capacitors;
fourth switches, wherein each of the fourth switches is coupled between the output of the second LNA and a respective one of the second capacitors;
a first mixer coupled to the first capacitors; and
a second mixer coupled to the second capacitors.

2. The system of claim 1, further comprising a control circuit configured to:
in a first mode, open all of the second switches and close one or more of the first switches based on a first set of bits; and
in a second mode, open all of the first switches and close one or more of the second switches based on a second set of bits.

3. The system of claim 1, wherein the first capacitors include first binary-weighted capacitors and the second capacitors include second binary-weighted capacitors.

4. The system of claim 1, wherein the first LNA is configured to amplify radio frequency (RF) signals in a first frequency band and the second LNA is configured to amplify RF signals in a second frequency band different from the first frequency band.

5. The system of claim 4, wherein the first frequency band is below one GHz and the second frequency band is above one GHz.

6. The system of claim 1, further comprising a frequency synthesizer coupled to the first mixer and the second mixer, wherein the frequency synthesizer is configured to output a first local oscillator signal to the first mixer and output a second local oscillator signal to the second mixer.

7. The system of claim 6, wherein the first local oscillator signal and the second local oscillator signal have different frequencies.

8. The system of claim 1, wherein the first LNA comprises a first transistor having a first gate length, the second LNA comprises a second transistor having a second gate length, and the first gate length is longer than the second gate length.

9. The system of claim 1, further comprising:
a feedback resistor;
first feedback switches configured to selectively couple the feedback resistor between the output of the first LNA and an input of the first LNA; and
second feedback switches configured to selectively couple the feedback resistor between the output of the second LNA and an input of the second LNA.

10. The system of claim 9, further comprising a control circuit configured to:
in a first mode, close the first feedback switches and open the second feedback switches; and
in a second mode, open the first feedback switches and close the second feedback switches.

11. The system of claim 1, further comprising a control circuit configured to:
in a first mode, close one or more of the first switches based on a first set of bits and/or close one or more of the second switches based on a second set of bits, open all of the third switches, and open all of the fourth switches; and
in a second mode, close one or more of the third switches based on a third set of bits and/or close one or more of the fourth switches based on a fourth set of bits, open all of the first switches, and open all of the second switches.

12. The system of claim 1, further comprising:
a bypass path bypassing the first LNA and the second LNA;
fifth switches, wherein each of the fifth switches is coupled between the bypass path and a respective one of the first capacitors; and
sixth switches, wherein each of the sixth switches is coupled between the bypass path and a respective one of the second capacitors.

13. The system of claim 1, further comprising:
a third LNA;
fifth switches, wherein each of the fifth switches is coupled between an output of the third LNA and a respective one of the first capacitors; and
sixth switches, wherein each of the sixth switches is coupled between the output of the third LNA and a respective one of the second capacitors.

14. The system of claim 13, further comprising:
a fourth LNA;
seventh switches, wherein each of the seventh switches is coupled between an output of the fourth LNA and a respective one of the first capacitors; and
eighth switches, wherein each of the eighth switches is coupled between the output of the fourth LNA and a respective one of the second capacitors.

15. The system of claim 14, wherein each of the first LNA and the third LNA is configured to amplify radio frequency (RF) signals in a first frequency band and each of the second LNA and the fourth LNA is configured to amplify RF signals in a second frequency band different from the first frequency band.

16. A system for wireless communications, comprising:
a first low-noise amplifier (LNA);
a second LNA;
capacitors;
first switches, wherein each of the first switches is coupled between an output of the first LNA and a respective one of the capacitors;
second switches, wherein each of the second switches is coupled between an output of the second LNA and a respective one of the capacitors; and
a mixer coupled to the capacitors.

17. The system of claim 16, further including a control circuit configured to:
in a first mode, open all of the second switches and close one or more of the first switches based on a first set of bits; and
in a second mode, open all of the first switches and close one or more of the second switches based on a second set of bits.

18. The system of claim 16, wherein the capacitors comprise binary-weighted capacitors.

19. The system of claim 16, wherein the first LNA is configured to amplify radio frequency (RF) signals in a first frequency band and the second LNA is configured to amplify RF signals in a second frequency band different from the first frequency band.

20. The system of claim 16, wherein the first LNA comprises a first transistor having a first gate length, the second LNA comprises a second transistor having a second gate length, and the first gate length is longer than the second gate length.
